(19) United States
(12) Patent Application Publication
(10) Pub. No.: US 2019/0392495 A1
(43) Pub. Date: Dec. 26, 2019

(54) METHOD AND SYSTEM FOR EXCHANGING PRODUCTS

(71) Applicant: HONDA MOTOR CO., LTD., Tokyo (JP)

(72) Inventors: Eric OHKI, Rancho Palos Verdes, CA (US); Christopher John TARCHALA, Torrance, CA (US)

(21) Appl. No.: 16/014,857

(22) Filed: Jun. 21, 2018

(51) Int. Cl. G06Q 30/06; G06Q 10/02

(52) U.S. Cl. CPC G06Q 30/0601; G06Q 10/02; G06Q 30/0643

(57) ABSTRACT

Aspects of the present disclosure include methods, apparatus, and computer readable medium for receiving a first information relating to a plurality of available products for exchange/rent and available time period associated with each product of the plurality of available products, displaying the plurality of available products in a calendar view including visual representations of the available time period associated with each product, receiving, from a requester, a request for a temporary exchange of an offered product from the requester for a requested product of the plurality of available products, receiving, an acceptance of the request, and transmitting a second information indicating the temporary exchange of the offered product for the requested product.

### TECHNICAL FIELD

The present disclosure generally relates to exchanging equipment, vehicles, and/or other products.

### BACKGROUND

Individual consumers may own one or more products, such as automobiles, all-terrain vehicles, motorcycles, watercrafts, and other vehicles and equipment (as used herein, examples of “equipment” include, for example, leaf blowers and lawnmowers; examples of “vehicles” include, for example, automobiles and all-terrain vehicles (ATVs); “products” as used herein is includes of both “equipment” and “vehicles”). However, many products may be under-utilized. For example, a recreational watercraft may be used by the owner only seasonally and during weekends. Many will purchase a generator for emergencies and are seldom used. Certain equipment, such as snow blowers, and tillers, may likewise be used seasonally/sporadically throughout the year. Increased product utilization may thus be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Aspects of the present disclosure include methods, apparatus, and computer readable medium for receiving a first information relating to a plurality of available products for exchange and available time period associated with each product of the plurality of available products, displaying the plurality of available products in a calendar view including visual representations of the available time period associated with each product, receiving, from a requester, a request for a temporary exchange of an offered product for a requested product of the plurality of available products, receiving, from a user, an acceptance of the request, and transmitting a second information indicating the temporary exchange of the offered product for the requested product.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates a schematic view of an example operating environment of a device exchange system in accordance with aspects of the present disclosure:

FIG. 2 illustrates an example of a computer system for implementing a method of exchanging products in accordance with aspects of the present disclosure;

FIG. 3 illustrates a block diagram of various exemplary system components, in accordance with aspects of the present disclosure.

FIGS. 4A-C illustrate examples of graphical user interfaces of a software application for exchanging products:

FIG. 5A-C illustrate more examples of graphical user interfaces of a software application for exchanging products;

FIGS. 6A-B illustrate still more examples of graphical user interfaces of a software application for exchanging products;

FIG. 7A-C illustrate some examples of graphical user interfaces of a software application for exchanging products:

FIGS. 8A-B illustrate certain examples of graphical user interfaces of a software application for exchanging products;

FIG. 9 illustrates a method of exchanging products; and

FIG. 10 illustrates examples of graphical user interfaces of a software application for exchanging products.

### DETAILED DESCRIPTION

The following includes definitions of selected terms employed herein. The definitions include various examples and/or forms of components that fall within the scope of a term and that may be used for implementation. The examples are not intended to be limiting.

A “processor,” as used herein, processes signals and performs general computing and arithmetic functions. Signals processed by the processor may include digital signals, data signals, computer instructions, processor instructions, messages, a bit, a bit stream, or other computing that may be received, transmitted and/or detected.

A “bus,” as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols, such as Controller Area network (CAN), Local Interconnect Network (LIN), among others.

A “memory,” as used herein may include volatile memory and/or non-volatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and/or direct RAM bus RAM (DRRAM).

An “operable connection,” as used herein may include a connection by which entities are “operably connected”, is one in which signals, physical communications, and/or logical communications may be sent and/or received. An operable connection may include a physical interface, a data interface and/or an electrical interface.

A “vehicle,” as used herein, refers to any moving vehicle that is powered by any form of energy. A vehicle may carry human occupants or cargo. The term “vehicle” includes, but is not limited to: cars, trucks, vans, minivans, SUVs, motorcycles, scooters, ATVs, generators, lawnmowers boats, personal watercraft, and aircraft. In some cases, a motor vehicle includes one or more engines.

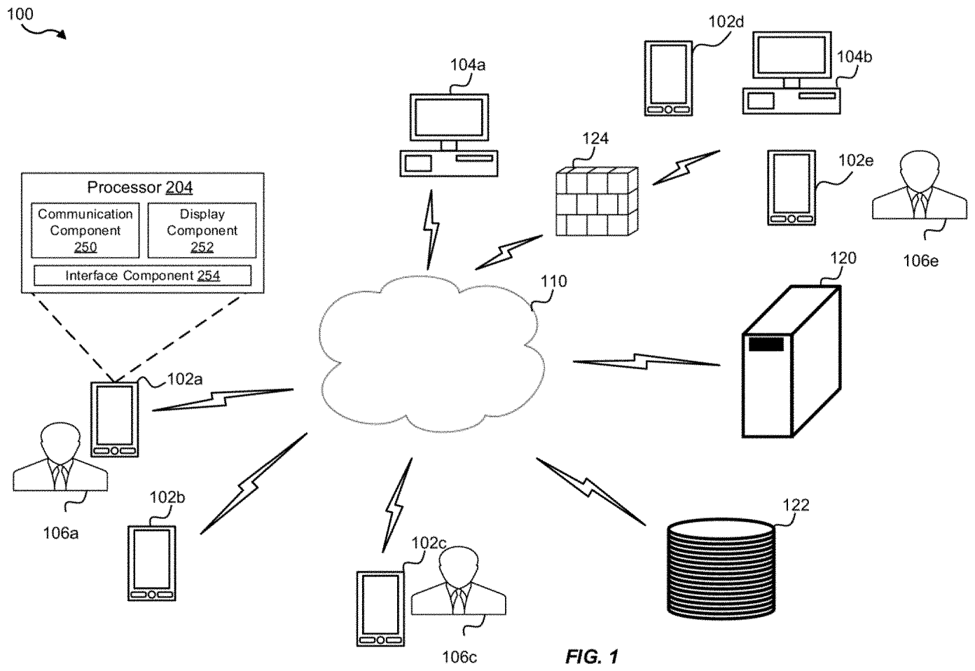

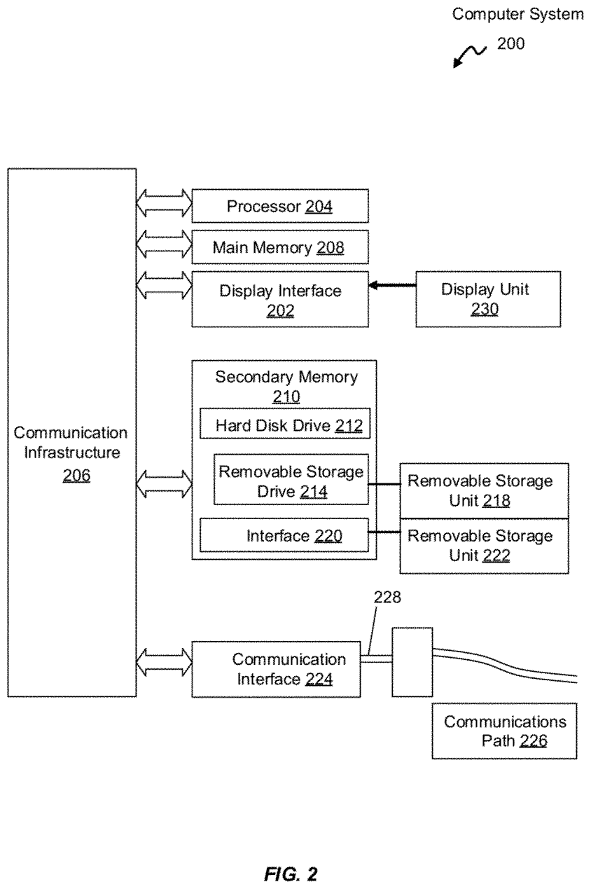

Turning to FIG. 1, a schematic view of a non-limiting example of an operating environment 100 for exchanging products may include mobile devices 102a-e, desktop computers 104a-b, a communication network 110, a server 120, a network storage device 122, and a firewall 124. Examples of mobile devices may include cellular phones, personal digital assistants, tablet computers, smart phones, and mobile phones. The server 120 may store information relating to the products owned by users of the mobile devices 102a-e and the desktop computers 104a-b. Alternatively, some or all the information relating to the products may be stored in the network storage device 122. The mobile devices 102a-c may communicate with the server 120 via the communication network 110, and the mobile devices 102d-e may communicate with the server 120 through the firewall 124 and the communication network 110. In some implementations, the mobile devices 102a-e and the desktop computers 104a-b may be implemented by general computer systems, such as a computer system 200 shown in FIG. 2.

Referring again to FIG. 1, in some implementations, the user of the mobile device 102a may exchange or share products owned by the user via a software application in the mobile device 102a. In particular, the software application may be implemented as one or more components, such as a communication component 250, a display component 252, and an interface component 254. The communication component 250, display component 252, and interface component 254 may be implemented in hardware, software, or a combination of hardware and software within the processor 204.

Still referring to FIG. 1, in some implementations, a user 106a of the mobile device 102a may input, via the interface component 254 of the mobile device 102a, information relating to available products that the user 106a intends to exchange or share. The available products may include vehicles, motorcycles, all-terrain vehicles, watercrafts, lawn mowers, sod cutters, and edging equipment, for example. The information may include rental costs, available time period for exchanging, colors of products, horsepower information, fuel types, fuel efficiencies, and other relevant information. The communication component 250 of the mobile device 102a may upload the information relating to the available products. The information may be stored in the server 120 and/or network storage device 122. The communication component 250 of the mobile device 102e, for example, may download information relating to the available products uploaded by the user 106a for a user 106e of the mobile device 102e. Next, the user 106e may view the available products displayed by the display component 252 of the mobile device 102e, and select one of the available products via the interface component 254 of the mobile device 102e.

As a compensation for using the selected product, the user 106e may propose to rent the selected product at an agreed upon rate, or to lend an offered product owned by the user 106e for temporary use by the user 106a in exchange for the selected product. In some examples, the communication component 250 of the mobile device 102e may upload a request, including the selection of the selected product and an offer to rent the selected product or exchange for the offered product, to the server 120 (through the firewall 124 and the communication network 110). The communication component 250 of the mobile device 102a may receive the request from the server 120. The user 106a may elect to accept, via the interface component 254, the offer to rent/lease the selected product, the offer to exchange the selected product for the offered product, or reject the offer(s) by the user 106e. In some examples, the users 106a. 106e, and a user 106c may belong to an organization, such as an employer, a club, a community, a neighborhood group, and an association, among other organizations.

Aspects of the present disclosure may be implemented using hardware, software, or a combination thereof and may be implemented in one or more computer systems or other processing systems. In an aspect of the present disclosure, features are directed toward one or more computer systems capable of carrying out the functionality described herein. An example of such the computer system 200 is shown in FIG. 2.

The computer system 200 includes one or more processors, such as the processor 204. The processor 204 is connected to a communication infrastructure 206 (e.g., a communications bus, cross-over bar, or network). Various software aspects are described in terms of this example computer system. After reading this description, it will become apparent to a person skilled in the relevant art(s) how to implement aspects of the disclosure using other computer systems and % or architectures.

The computer system 200 may include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212, and/or a removable storage drive 214, representing a floppy disk drive, a magnetic tape drive, an optical disk drive, a universal serial bus (USB) flash drive, etc. The removable storage drive 214 reads from and/or writes to a removable storage unit 218 in a well-known manner. Removable storage unit 218 represents a floppy disk, magnetic tape, optical disk, USB flash drive etc., which is read by and written to removable storage drive 214. As will be appreciated, the removable storage unit 218 includes a computer usable storage medium having stored therein computer software and/or data.

Alternative aspects of the present disclosure may include secondary memory 210 and may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, an RF link and/or other communications channels. In this document, the terms “computer program medium” and “computer usable medium” are used to refer generally to media such as a removable storage drive 218, a hard disk installed in hard disk drive 212, and signals 228. These computer program products provide software to the computer system 200. Aspects of the present disclosure are directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features in accordance with aspects of the present disclosure, as discussed herein. In particular, the computer programs, when executed, enable the processor 204 to perform the features in accordance with aspects of the present disclosure. Accordingly, such computer programs represent controllers of the computer system 200.

In an aspect of the present disclosure where the method is implemented using software, the software may be stored in a computer program product and loaded into computer system 200 using removable storage drive 214, hard drive 212, or communications interface 220. The control logic (software), when executed by the processor 204, causes the processor 204 to perform the functions described herein. In another aspect of the present disclosure, the system is implemented primarily in hardware using, for example, hardware components, such as application specific integrated circuits (ASICs). Implementation of the hardware state machine so as to perform the functions described herein will be apparent to persons skilled in the relevant art(s).

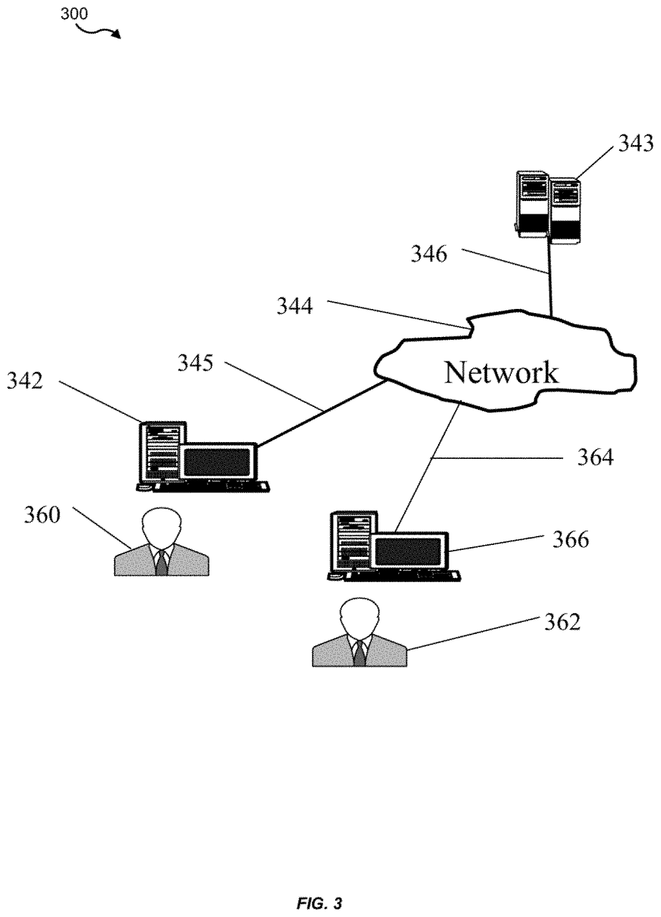

FIG. 3 illustrates a block diagram of various example system components, in accordance with an aspect of the present disclosure. FIG. 3 shows a communication system 300 usable in accordance with aspects of the present disclosure. The communication system 300 includes one or more accessors 360, 362 (also referred to interchangeably herein as one or more “users”) and one or more terminals 342, 366. In one aspect, data for use in accordance with aspects of the present disclosure is, for example, input and/or accessed by accessors 360, 362 via terminals 342, 366, such as personal computers (PCs), minicomputers, mainframe computers, microcomputers, telephonic devices, or wireless devices, such as personal digital assistants (“PDAs”) or a hand-held wireless devices coupled to a server 343, such as a PC, minicomputer, mainframe computer, microcomputer, or other device having a processor and a repository for data and/or connection to a repository for data, via, for example, a network 344, such as the Internet or an intranet, and couplings 345, 346, 364. The couplings 345, 346, 364 include, for example, wired, wireless, or fiberoptic links. In another example variation, the method and system in accordance with aspects of the present disclosure operate in a stand-alone environment, such as on a single terminal.

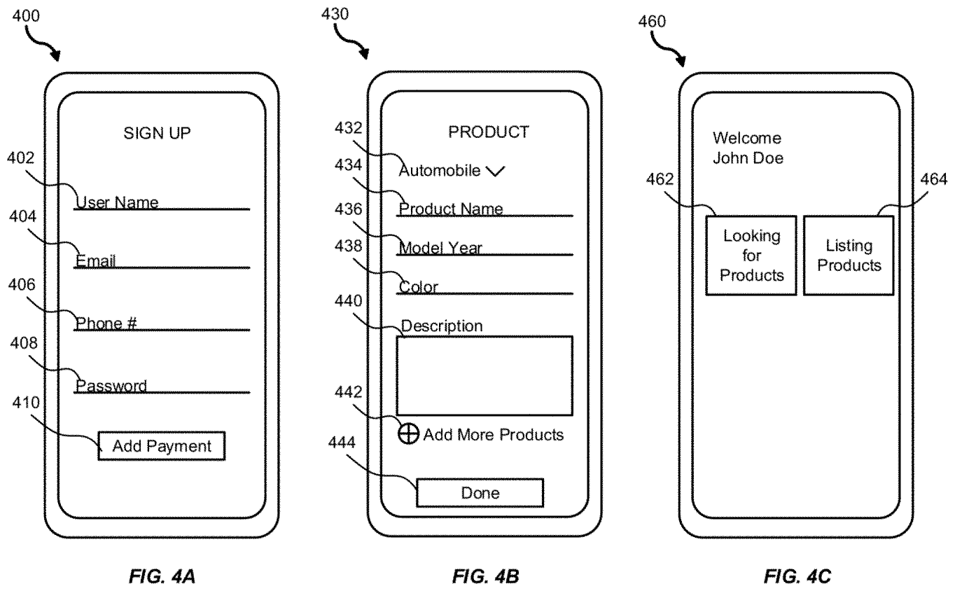

Referring to FIGS. 4A-C, therein shown are examples of graphical user interfaces 400, 430, 460 of the software application for exchanging products. In FIG. 4A, the graphical user interface 400 of the software application may display a Sign Up page with a user name field 402, an email field 404, a phone number field 406, a password field 408, and a control 410 for adding payment. A user, such as the user 106a of the mobile device 102a, may enter a user name (e.g., John Doe) into the user name field 402, an email address into the email address field 404, a phone number into the phone number field 406, a password into the password field 408, and payment information (e.g., credit card number and expiration, checking account number and routing number) via the control 410.

Referring to FIG. 4B, in some implementations, the graphical user interface 430 of the software application may display a Product page with a product type control 432, a product name field 434, a model year field 436, a color field 438, a description text box 440, an product addition control 442, and a confirmation control 444. The Product page may allow the user 106a to input information relating to product(s) that the user may want to exchange or share, if any, with other users, such as the user 106e. In some examples, the user 106a may by-pass the Product page by selecting the confirmation control 444 without inputting any information. Alternatively, the user 106a may optionally select a product type (e.g., automobiles, watercrafts, motorcycles) using the product type control 432. The user 106a may optionally input a product name (e.g., Red Car) into the product name field 434, a model year of the product (e.g., 2012) into the model year field 436, a color of the product (e.g., black) into the color field 438, and descriptions of the product into the description text box 440. In some examples, the user 106a may add more products by using the product addition control 442. In other examples, the user 106a may end leave the Product page by pressing or touching the confirmation control 444.

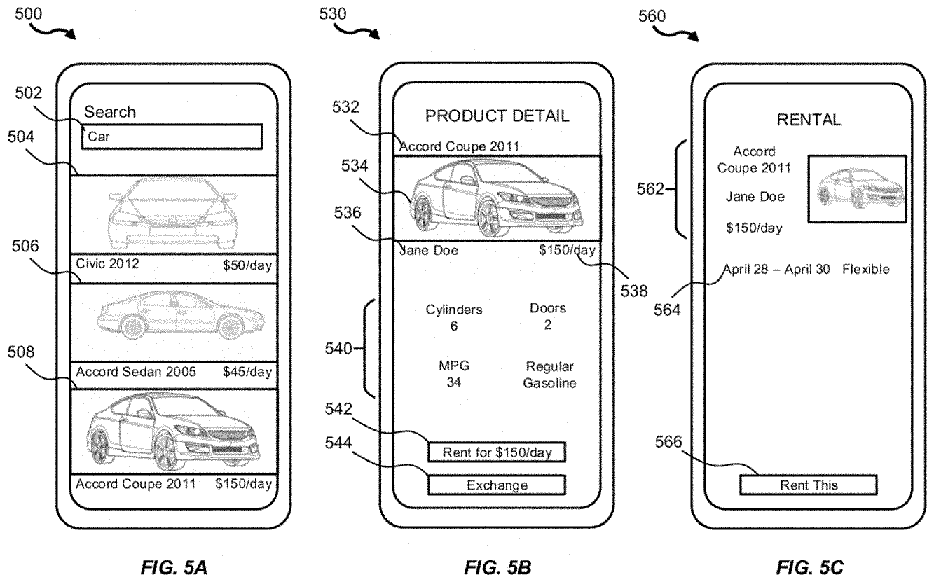

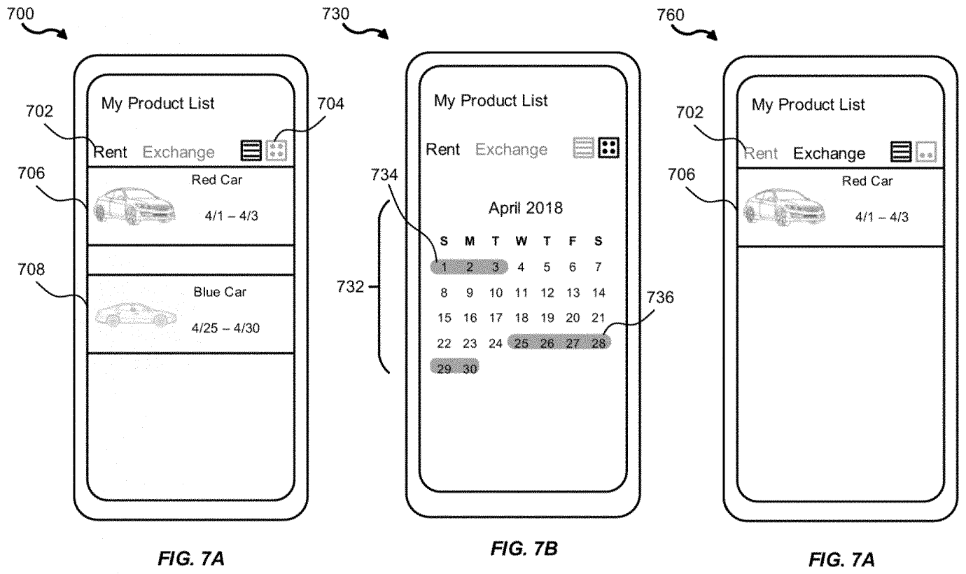

Referring to FIG. 4C, in some implementations, the graphical user interface 460 of the software application may display a Welcome page with a product search control 462 and a product list control 464. By pressing the product search control 462 the software application may redirect the graphical user interface 460 to a graphical user interface 500 shown in FIG. 5A. By pressing the product list control 464, the software application may redirect the graphical user interface 460 to a graphical user interface 700 shown in FIG. 7A, and further described below.

Referring now to FIG. 5A, in some implementations, the graphical user interface 500 of the software application may display a Product Search page with a search box 502, a first search result 504, a second search result 506, and a third search result 508. For example, the user 106a may input a search term “car” into the search box 502. The graphical user interface 500 may display the search results 502, 504, 506, including pictures, models, years, rental costs, and other relevant information. The user 106a may select, for example, the third search result 506 for viewing.

Referring now to FIG. 5B, in some implementations, the graphical user interface 530 may display a Product Detail page with a product name 532 (i.e., Accord Coupe 2011), a product picture 534, a product owner 536 (e.g., the user 106c named Jane Doe), a product rental cost 538 (i.e., $150/day), a product description 540 (e.g., number of cylinders, number of doors), a rental control 542, and an exchange control 544. After viewing the information on the Product Detail page, the user 106a may decide to rent or exchange the vehicle associated with the third search result 508 (i.e., Accord Coupe 2011). The user 106a may rent the Accord Coupe 2011 by pressing the rental control 542, which may cause the software application to redirect the graphical user interface 530 to a graphical user interface 560 that displays the Rental page. The Rental page may include a summary 562 of the rental product (i.e., Accord Coupe 2011), a rental period 564, and a rental confirmation control 566. The user 106a may review the information on the Rental page, and confirm the rental by pressing the rental continuation control 566. The communication component 250 of the mobile device 102a may transmit the confirmation to the server 120.

In optional implementations, after confirming the rental, the software application may provide one or more interfaces for the user 106a to communicate (e.g. email, instant message, telephone) with the user 106c. The software application may also provide an interface for the user 106a to rate the rental product.

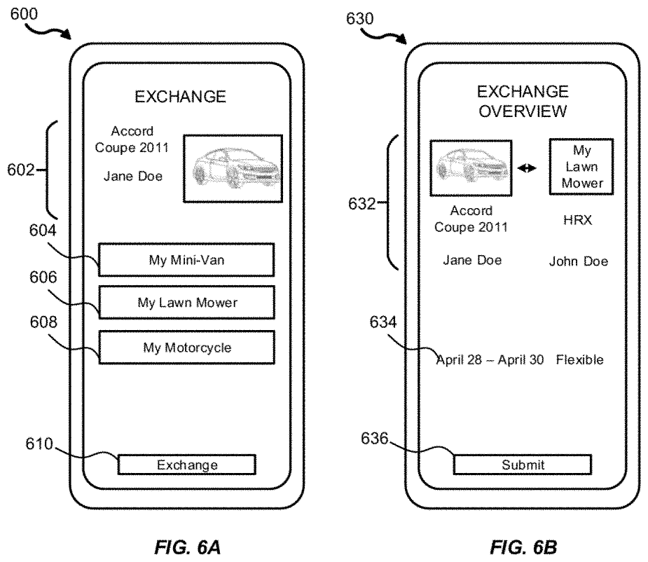

Referring now to FIGS. 5B and 6A, in some implementations, the user 106a may request an exchange for the Accord Coupe 2011 by pressing the exchange control 544, which may cause the software application to redirect the graphical user interface 530 to a graphical user interface 600 that displays the Exchange page. The Exchange page may include a summary 602 of the exchange product (i.e., Accord Coupe 2011), a first offered product 604, a second offered product 606, a third offered product 608, and an exchange control 610. The first, second, and third offered products 604, 606.608 may be products owned by the user 106a. In some examples, the user 106a may select one of the first, second, and third offered products 604, 606, 608 as an offer to exchange for the exchange product. For example, the user 106a may select the second offered product (i.e., My Lawn Mower) and press the exchange control 610 to proceed.

Referring to FIG. 6B, a graphical user interface 630 may display an Exchange Overview page including a summary 632, an exchange period 634, and an exchange confirmation control 636. The user 106a may review the information on the Exchange Overview page, and confirm the exchange by pressing the exchange confirmation control 636. The communication component 250 of the mobile device 102a may transmit the confirmation to the server 120.

In optional implementations, the communication component 250 of the mobile device 102c belonging to the user 106c may receive the rental or exchange request from the server 120. The display component 252 of the mobile device 102c may show an interface that allows the user 102c to accept, reject, defer, or modify the rental or exchange request.

Referring now to FIGS. 4C and 7A, in certain implementations, if the user 106a pressed the product list control 464, the software application may redirect the interface 460 to the graphical user interface 700 that may display a list view of a My Product List page. The My Product List page includes a Rent/Exchange toggle control 702, a view toggle control 704, a first product information 706, and a second product information 708. The user 106a may use the Rent/Exchange toggle control 702 to toggle between lists for products for rent and products for exchange by the user 106a. The user 106a may use the view toggle control 704 to toggle between the list view of the My Product List page (shown in FIG. 7A), and a calendar view of the My Product List page (shown in FIG. 7B). The first product information 706 and the second product information 708 show products available for rent owned by the user 106a. The first and second product information 706, 708 include information indicating the availability of the products. For example, the “Red Car” shown in the first product information 706 may be available from April 1^{st} to April 3^{rd}. The “Blue Car” shown in the second product information 708 may be available from April 25^{th} to April 30^{th}.

Referring to FIG. 7B, in certain implementations, the user 106a may toggle to a graphical user interface 730 showing the calendar view of the My Product List page. The calendar view of the My Product List page includes a calendar 732, a first highlighted portion 734, and a second highlighted portion 736. The calendar 732 may display a day, a work week, a week, a month, two months, three months, or a year, for example. The first highlighted portion 734 may indicate the available dates (i.e., April 1^{st} to April 3^{rd}) for rental/exchange of the “Red Car” and the second highlighted portion 736 may indicate the available dates (i.e., April 25^{th} to April 30^{th}) for rental/exchange of the “Blue Car.” The calendar view of the My Product List page may help the user 106a to quickly view the availabilities of the products.

Referring to FIG. 7C, in some implementations, the user 106a may toggle to a graphical user interface 760 showing the list for products for exchange using the Rent/Exchange toggle control 702. The list may include the first product information 706. The “Red Car” may be available for rent and control.

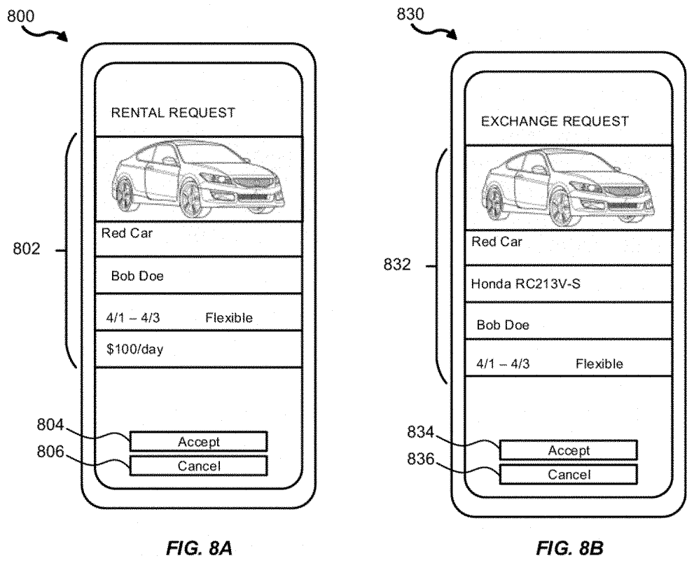

Referring to FIGS. 7A and 8A, in some implementations, if the user 106a a presses the first product information 706, the software application may redirect the graphical user interface 700 to an interface 800 showing a Rental Request page including a rental offer 802 for the Red Car, an acceptance control 804, and a cancellation control 806. The rental offer 802 may indicate an offer made by the user 106e (named Bob Doe), for example, and a rental period (i.e., April 1^{st} to April 3^{rd}). If the user 106a accepts the offer, the user may press the acceptance control 804. Otherwise, the user may press the cancellation control 806 to return to the graphical user interface 700.

Referring to FIGS. 7C and 8B, in some implementations, if the user 106a presses the first product information 706 within the graphical user interface 760, the software application may redirect the graphical user interface 760 to an interface 830 showing an Exchange Request page including an exchange offer 832 for the Red Car, an acceptance control 834, and a cancellation control 836. The rental offer 832 may indicate an offer made by the user 106e and a rental period from April 1^{st} to April 3^{rd}. The offer may include exchanging the Red Car for a Honda RC213V-S owned by the user 106e. If the user 106a accepts the offer, the user may press the acceptance control 834. Otherwise, the user may press the cancellation control 836 to return to the graphical user interface 760.

The communication component 250 may transmit the acceptance of the offer to the server 120.

In optional implementations, the user 106e may provide feedback after renting or exchanging for the Red Car. The feedback may include information relating to the conditions of the Red Car, for example.

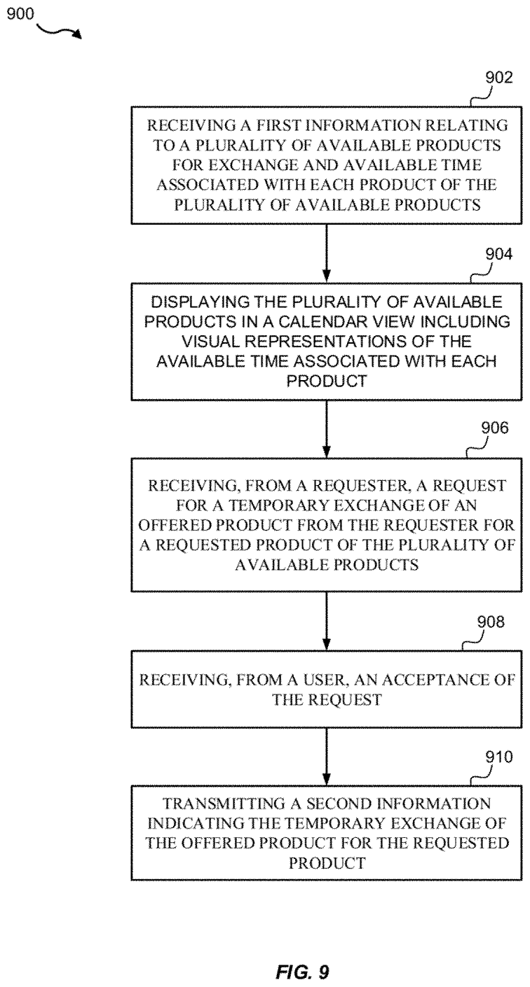

Turning to FIG. 9, a method 900 of exchanging products may be implemented by, for example, the mobile devices 102a-e and the desktop computers 104a-b. At block 902, the method 900 may receive a first information relating to a plurality of available products for exchange and available time period associated with each product of the plurality of available products. For example, the interface component 254 may receive, from the user 106a, information relating to the Red Car. The Red Car may be available for exchange from April 1^{st} to April 3^{rd}.

At block 904, the method 900 may display the plurality of available products in a calendar view including visual representations of the available time period associated with each product. For example, the display component 252 may display the first highlighted portion 734 to indicate the available time period of the Red Car.

At block 906, the method 900 may receive, from a requester, a request for a temporary exchange of an offered product from the requester for a requested product of the plurality of available products. For example, the communication component 250 may receive, from the user 106e, a request for a temporary exchange of a Honda RC213V-S for the Red Car.

At block 908, the method 900 may receive, from a user, an acceptance of the request. For example, the interface component 254 may receive an acceptance for the exchange.

At block 910, the method 900 may transmit a second information indicating the temporary exchange of the offered product for the requested product. For example, the communication component 250 may transmit the acceptance of the temporary exchange to the server 120.

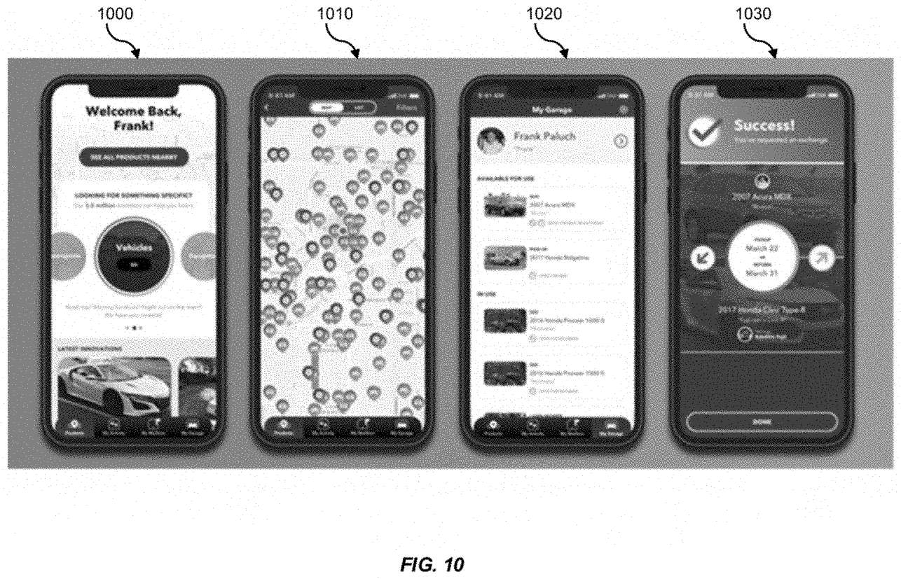

Turning now to FIG. 10, therein shown are examples of graphical user interfaces 1000, 1010, 1020, 1030 of software for product exchange/rental. The graphical user interface 1000 shows an introductory page of the software for exchanging/renting products. The graphical user interface 1010 shows a map-view of products available for exchange or rent within a geographical area. The graphical user interface 1020 may show a My-Product page that lists the products owned by the user. The graphical user interface 1030 may show a confirmation page that confirms a request for exchange or rental.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of exchanging products, comprising:
receiving first information relating to a plurality of available products for exchange and an available time period associated with each product of the plurality of available products;
displaying the plurality of available products in a calendar view including visual representations of the available time period associated with each product;
receiving a request for a temporary exchange of an offered product for a requested product of the plurality of available products;
receiving an acceptance of the request; and
transmitting second information indicating the temporary exchange of the offered product for the requested product.

2. The method of claim 1, comprising:
prior to receiving the first information related to the plurality of available products, receiving user information associated with a user; and
registering the user using the user information.

3. The method of claim 1, wherein the visual representations of available time period includes availability information associated with each product of the plurality of available products.

4. The method of claim 1, wherein:
displaying the plurality of available products in the calendar view includes displaying a calendar and the available time period associated with each product of the plurality of available products in a graphical user interface; and
receiving the acceptance for the temporary exchange includes receiving the acceptance through the graphical user interface.

5. The method of claim 1, comprising providing an electronic mail interface, a telephonic interface, or an instant messaging interface for communication relating to the requested product.

6. The method of claim 1, comprising toggling the plurality of available products between the calendar view and a list view.

7. The method of claim 1, comprising receiving feedback relating to the exchange.

8. A device comprising:
a memory;
a display; and
one or more processors operatively coupled to the memory and the display, the one or more processors performing the steps of:
receiving first information relating to a plurality of available products for exchange and an available time period associated with each product of the plurality of available products;
displaying, via the display, the plurality of available products in a calendar view including visual representations of the available time period associated with each product;
receiving a request for a temporary exchange of an offered product for a requested product of the plurality of available products;
receiving an acceptance of the request; and
transmitting second information indicating the temporary exchange of the offered product for the requested product.

9. The mobile device of claim 8, wherein the one or more processors further perform the steps of:
receiving, prior to receiving the plurality of available products, user information associated with a user, and
registering the user using the user information.

10. The mobile device of claim 8, wherein the visual representations of available time period includes availability information associated with each product of the plurality of available products.

11. The mobile device of claim 8, wherein:
displaying the plurality of available products in the calendar view includes displaying a calendar and the available time period associated with each product plurality of available products in a graphical user interface; and
receiving the acceptance for the temporary exchange includes receiving the acceptance from the user through the graphical user interface.

12. The mobile device of claim 8, wherein the one or more processors further perform the step of providing an electronic mail interface, a telephonic interface, or an instant messaging interface for communication relating the requested product.

13. The mobile device of claim 8, wherein the one or more processors further perform the step of provide to the plurality of available products between the calendar view and a list view.

14. The mobile device of claim 8, wherein the one or more processors further perform the step of receive feedback relating to the exchange.

15. A system for displaying product availability, comprising:
a first graphical user interface that receives user input including one or more products available for use and available dates of the one or more products;
a second graphical user interface having:
a type toggle control for switching between a first calendar view and a second calendar view, and
a calendar having a plurality of dates and at least one highlighted date, wherein the at least one highlighted date indicates the available dates that the one or more products are available for use; and
a third graphical user interface that displays a request to use the one or more products during the at least one highlighted date.

16. The system of claim 15, wherein the request to use the one or more products further includes a rental request to rent the one or more products or an exchange request to exchange the one or more products with an offered product.

17. The system of claim 16, further comprises a fourth graphical user interface including an acceptance control for a rental request or an exchange request.

18. The system of claim 16, wherein the calendar displays a day, a work week, a week, a month, two months, or a year.

19. The system of claim 15, wherein:
the one or more products include a first plurality of products for exchange having a first plurality of highlighted dates and a second plurality of products for rent having a second plurality of highlighted dates, wherein the first plurality of highlighted dates indicates the available dates that the first plurality of products are available for exchange and the second plurality of highlighted dates indicates the available dates that the second plurality of products are available for rent, the first plurality of highlighted dates and the second plurality of highlighted dates are part of the at least one or more highlighted dates; and
the first calendar view displays the first plurality of highlighted dates and the second calendar view displays the second plurality of highlighted dates.

20. The system of claim 19, wherein the second graphical user interface further comprises a view toggle control for switching between the second graphic user interface and a fourth graphical user interface that displays the first plurality of products for exchange or the second plurality of products for rent.
